(19) United States
(12) Patent Application Publication
(10) Pub. No.: US 2015/0230059 A1
(43) Pub. Date: Aug. 13, 2015

(54) Motion State Notifying Device and Method

(71) Applicant: Kirk Damman, St. Louis, MO (US)

(72) Inventor: Kirk Damman, St. Louis, MO (US)

(21) Appl. No.: 14/620,023

(22) Filed: Feb. 11, 2015

Related U.S. Application Data
(60) Provisional application No. 61/938,510, filed on Feb. 11, 2014.

(51) Int. Cl. H04W 4/02; H04W 88/04; H04W 4/00

(52) U.S. Cl. CPC H04W 4/027; H04W 4/008; H04W 88/04; H04W 4/005

(57) ABSTRACT

Systems and methods for the detection of a change in steady state. The systems generally comprise a detector device which is attached to an object of interest, the detector device will communicate with a remote repeater, which serves to relay the signal to a further remote computer, generally a mobile device. Generally, the later communication will utilize a different communication protocol from the first. The steady state detector may provide a wide array of functionality from acting as a security system to detect the unauthorized movement of an object, to a fencing system to detect unexpected ingress or egress through a virtual perimeter.

### CROSS REFERENCE TO RELATED APPLICATION(S)

This application claims benefit of U.S. Provisional Patent Application Ser. No. 61/938,510, filed Feb. 11, 2014, the entire disclosure of which is herein incorporated by reference.

### BACKGROUND

1. Field of the Invention

This disclosure is related to a system of distributed motion sensing devices and a ventral node for detection of the disruption of a steady state of a complex environment.

2. Description of the Related Art

The use of small locators is becoming ubiquitous. Devices such as the TrackR™ allow for a person to place a small locator device with their wallet, keys, or other easily lost device to enable them to quickly locate the locator device and zero in on the location of their missing items. Further, items such as RFID tags are now being placed in products for purposes of inventory control and to thwart theft of them.

All these devices, however, generally share a couple of facets. The first is that they are generally designed to locate devices geospatially. That is, the devices are intended to tell you the position of the device (and therefore the thing it is attached to) relative to some other point in space. Thus, you can determine that your keys are under the couch by the fact that they are indicated to be in front of where you are currently holding your smart phone and only a few feet away. Similarly, an RFID tag can be used to indicate that a particular product is currently going past a particular point (for example, a loading dock doorway).

While these devices have a myriad of uses, one thing they are not good for is monitoring a steady state. That is, the devices are designed to be actively called on for returning a position. They find the location of your keys when the user requests the location on another device or they indicate when a product is moving past a particular sensor and is at a particular location.

Motion sensing has been used in a variety of applications one of which is in residential and commercial security. The idea behind a motion sensor is to simply see motion as it passes in front of a window on the device. In a security system, when it is armed, one expects that no authorized person is present and, therefore, the house should be a steady state with nothing moving therein. Thus, when the system detects movement of a type similar to a human being, it is presumed to be an unauthorized presence and an alarm can be sounded.

Security systems also use certain forms of magnetic “triggers” to detect human actions. For example, magnetic devices can be placed on doors and windows in a fashion where if two pieces of the device separate from each other, the door is presumed to be opening, and an alarm is triggered.

These types of security systems related to motion detection, however, all suffer from a couple of major flaws. Motion detectors are often bulky devices with relatively large power requirements (often being tied to a building's electrical system). Further, magnetic sensors can often be defeated by simply quickly closing the switch before the alarm is triggered (or quickly silencing it). Further, while these systems can be useful to monitor buildings where the activity in the building is in a steady state, they are not useful at all for detecting in areas with a steady state of motion or where the motion is not of a human actor, but of an object.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Described herein, among other things are systems and methods for a motion sensing tracker. The device is designed to be small and readily attachable to a variety of different objects. The device includes an internal motion sensor, such as an accelerometer, a battery or other source of power (including kinetic power generating systems), and a small wireless communication system which may communicate using any communication method or protocol known now or later discovered with a separate remote device called a repeater. The protocol will often be Bluetooth™.

The device is designed to be attached to an object which is expected to be in a steady state, whether one of stillness or of motion, and is designed to communicate when that steady state is interrupted the fact that the steady state has been interrupted. It may also be used to indicate when a device has crossed a virtual perimeter in an embodiment using the communication range of the transmitters to define the perimeter of interest.

There is disclosure herein, among other things, a system for detecting a change in steady state comprising: a detection device, said detection device attached to an object having a steady state and including a motion detector; a repeater remote from said detection device; and a receiver remote from both said detection device and said repeater; wherein, when motion is detected by said motion detector, said device transmits an indication of said motion to said repeater; and wherein, said repeater transmits an indication of said motion to said remote receiver.

In an embodiment of the system, the steady state is a stationary state.

In an embodiment of the system, the steady state is continuous or near-continuous motion.

In an embodiment of the system, the device transmits to said repeater using a short ranged and low power communication protocol.

In an embodiment of the system, the protocol is Bluetooth™.

In an embodiment of the system, the repeater transmits to said receiver using a computer network.

In an embodiment of the system, the network is the Internet.

In an embodiment of the system, the repeater transmits to said receiver using a cellular telephone signal.

In an embodiment of the system, the remote receiver is a computer.

In an embodiment of the system, the remote receiver is a mobile device.

There is also described herein, a system for detecting the location of an object comprising: a detection device, said detection device attached to an object and including a transmitter; a repeater remote from said detection device and including a receiver; and a computer remote from both said detection device and said repeater and in communication with said repeater; wherein, said repeater automatically triggers an alarm situation when said transmitter gets into communication with said receiver; and wherein, said alarm situation is transmitted by said repeater to said computer.

In an embodiment of the system, the computer is a mobile device.

In an embodiment of the system, the detection device transmits to said repeater using a short ranged and low power communication protocol.

In an embodiment of the system, the protocol is Bluetooth™.

In an embodiment of the system, the repeater transmits to said computer over a network.

In an embodiment of the system, the network is the Internet.

In an embodiment of the system, the repeater transmits to said receiver using a cellular telephone signal.

There is also described herein a system for detecting the location of an object comprising: a detection device, said detection device attached to an object and including a first transmitter and a second transmitter; a repeater remote from said detection device and including a receiver; and a computer remote from both said detection device and said repeater and in communication with said repeater; wherein, said repeater automatically triggers an alarm situation when said first transmitter loses communication with said receiver; wherein, said detection device switches from using said first transmitter to said second transmitter only when said first transmitter loses communication with said receiver; wherein said second transmitter communicates with said computer without using said repeater; and wherein, said alarm situation is transmitted by said repeater to said computer.

### BRIEF DESCRIPTION OF THE DRAWINGS

FIG. 1 Provides a block diagram of an embodiment of a motion detector which can be attached to an object.

FIG. 2 provides a diagram illustrating a motion detector communicating to a repeater which then communicates to a remote device.

FIG. 3 provides a diagram of a repeater perimeter detecting the approach of a device including a motion detector.

### DESCRIPTION OF THE PREFERRED EMBODIMENT(S)

There are a huge number of items which are generally retained in a steady state of stillness and for which any form of movement generally implies a problem unless the movement is being caused for a particular reason which is generally known to the owner of the object. A good example is a television. When placed in a person's home, or even on display in a store, the television would be expected to remain in the same place (relative to the Earth which of course is moving through space) without any form of movement for a relatively long period of time. Generally the television would only be moved if the television's owner was rearranging the room, or the television was to be purposefully transported to a new location (e.g. because it was sold).

Because it is expected to be maintained in this steady state, a device which detects the motion of the television in a fashion that would not correspond to an expected movement, would likely be able to detect an unauthorized movement. For example, that someone was attempting to steal the television.

Described herein are systems and methods for the detection of a change in steady state. The systems generally comprise a detector device which is attached to an object of interest, the detector device will communicate with a remote repeater, which serves to relay the signal to a further remote computer, generally a mobile device. Generally, the later communication will utilize a different communication protocol from the first. The steady state detector may provide a wide array of functionality from acting as a security system to detect the unauthorized movement of an object, to a fencing system to detect unexpected ingress or egress through a virtual perimeter. It may also detect changes of a stationary steady state to one of movement, or a state of continuous or near-continuous motion to one that is stationary.

Generally the systems and methods discussed herein will be accessed using a computational device and will be accessed by a user using a computer, mobile device, or other object interfacing with other computational systems via a network. For purposes of this disclosure, a mobile device may be, but is not limited to, a smart phone, tablet PC, e-reader, or any other type of mobile device capable of executing the described functions. Generally speaking, the mobile device is network-enabled and communicating with a server system providing services over a telecommunication network.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, smart phones, tablet computers, mobile devices, server farms, hardware appliances, minicomputers, mainframe computers, video game consoles, handheld video game products, and wearable computing devices including but not limited to eyewear, wristwear, pendants, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory.

Throughout this disclosure, terms used herein to describe or reference media holding software, including without limitation terms such as “media,” “storage media,” and “memory,” may include or exclude transitory media such as signals and carrier waves.

Throughout this disclosure, the terms “web,” “web site,” “web server,” “web client,” and “web browser” refer generally to computers programmed to communicate over a network using the HyperText Transfer Protocol (“HTTP”), and/or similar and/or related protocols including but not limited to HTTP Secure (“HTTPS”) and Secure Hypertext Transfer Protocol (“SHTP”). A “web server” is a computer receiving and responding to HTTP requests, and a “web client” is a computer having a user agent sending and receiving responses to HTTP requests. The user agent is generally web browser software.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g. “a remote host”), or may, in verb form, refer to a server providing a service over a network (“hosts a website”), or an access point for a service over a network.

Throughout this disclosure, the term “real time” generally refers to software performance and/or response time within operational deadlines that are effectively generally cotemporaneous with a reference event in the ordinary user perception of the passage of time for a particular operational context. Those of ordinary skill in the art understand that “real time” does not necessarily mean a system performs or responds immediately or instantaneously. For example, those having ordinary skill in the art understand that, where the operational context is a graphical user interface, “real time” normally implies a response time of about one second of actual time for at least some manner of response from the system, with milliseconds or microseconds being preferable. However, those having ordinary skill in the art also understand that, under other operational contexts, a system operating in “real time” may exhibit delays longer than one second, such as where network operations are involved which may include multiple devices and/or additional processing on a particular device or between devices, or multiple point-to-point round-trips for data exchange among devices. Those of ordinary skill in the art will further understand the distinction between “real time” performance by a computer system as compared to “real time” performance by a human or plurality of humans. Performance of certain methods or functions in real-time may be impossible for a human, but possible for a computer. Even where a human or plurality of humans could eventually produce the same or similar output as a computerized system, the amount of time required would render the output worthless or irrelevant because the time required is longer than how long a consumer of the output would wait for the output, or because the number and/or complexity of the calculations, the commercial value of the output would be exceeded by the cost of producing it.

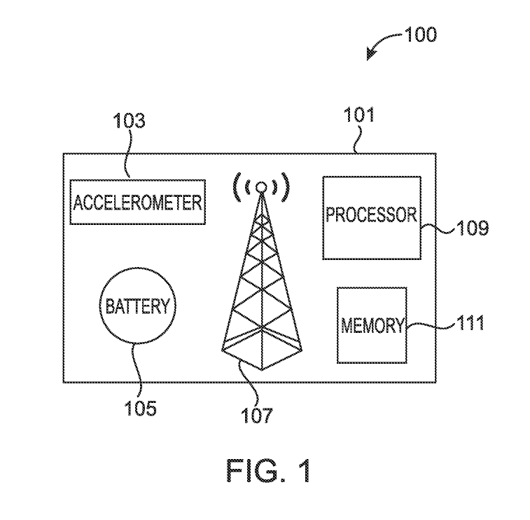

FIG. 1 shows a general block diagram of a first embodiment of a small device (100) which is designed to be attached to an object for the purpose of detecting unexpected and/or unauthorized movement of the object. The device (100) will generally comprise a housing (101) which will encapsulate a motion detector, such as an accelerometer (103), a battery or other self-contained power source (105), and a communication system (107). The device may also include a small digital processor or computer (109) and/or memory (111). The housing may be constructed to be solid, e.g. the components may be incased in a solid plastic resin, or may be a more standard housing.

The device (100) of FIG. 1 would be designed to be attached to an object with a generally steady state such as the television (201). This attachment may be in any manner. In an embodiment, the attachment is intended to be essentially permanent and may utilize strong bonding adhesives (such as, but not limited to, cyanoacrylates), welding, sonic welding, or connectors such as bolts or screws. The device (100) may also be manufactured as part of the object (201). As will become apparent later, it is not necessary that the connection be permanent or even difficult to remove and therefore in alternative embodiments lower strength connections such as hook and loop fastener, low strength adhesives, magnets, and related materials may be used.

The device (100) will generally be placed on the object (201) and the object (201) will be placed in a steady state situation. For example, the object (201) may be placed in a house on a TV stand. The device (100) may detect, using the motion detector (103) that a steady state has been reached because the same state has been detected for a predetermined period of time (For example, 1 minute, 5 minutes, or 10 minutes), or alternatively, the device (100) may be told it is in such a steady state by a signal received from a communication from an external transceiver in repeater (301). Regardless, once the device (100) has determined it is in steady state, it will enter a sleep state where the output of the motion detector is simply monitored for any change in motion.

In the event that the motion detector (103) detects a change in motion, the device (100) will generally promptly thereafter send a communication via communication system (107) to an external repeater (301) which includes a receiver (or transceiver) for receiving such a communication. The communication will generally be limited to an indication that the device (100) has detected a change in motion. The message may be as simple as that there is motion of some sort. Alternatively, specifics of the motion (such as duration, amplitude etc.) or the nature of the change can alternatively or additionally be sent.

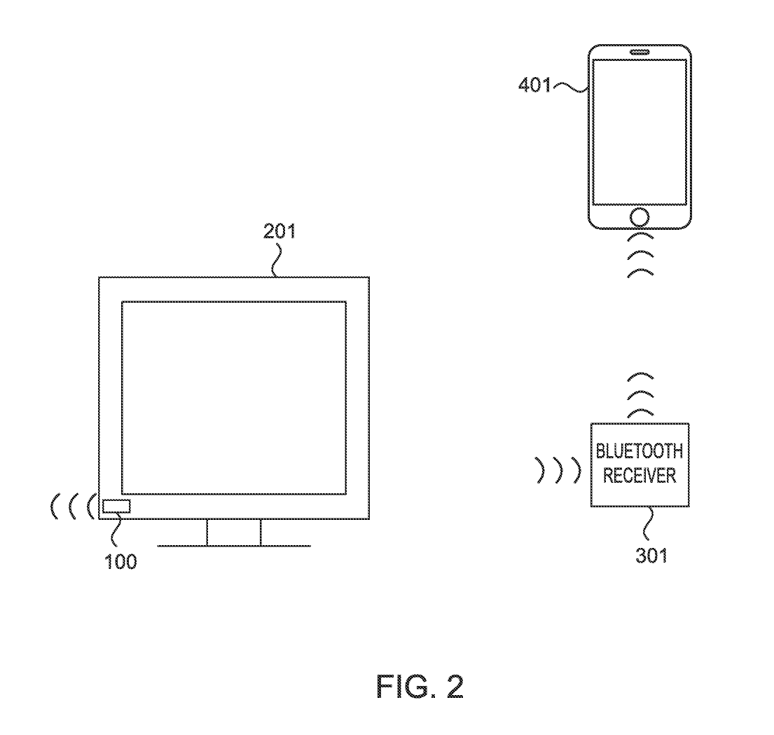

The repeater (301) may be any device or network of devices capable of receiving a communication and either supplying the information of that information to a monitoring system (such as a human user or a mechanized alarm controller such as those used in security systems) or in passing that information on to another receiver such as a user's mobile device (401). In the embodiment of FIG. 2, the repeater (301) comprises a Bluetooth receiver and processing circuitry (potentially including a processor) located in proximity to the device (100). The repeater (301), in addition to receiving the signal from the device (100) is also designed to forward the message to an additional receiver (401). In the depicted embodiment, this is by using wireless telephony to call a user's mobile device (401). Alternatively, the repeater (301) could access an attached network connection (e.g. a wired Internet connection) or any other form of wired or wireless communication network to which it has access. The repeater may be attached to an essentially continuous power source (such as an electrical grid) or may also include a self-contained power source (or both).

As should be apparent, should the device (100) detect movement, that movement will quickly be relayed to the user's mobile device (401) via the repeater (301). The user, upon seeing the message can determine if this movement is authorized, e.g. because the user is actually moving the device (100) themselves, or is unauthorized, which could indicate that the object (201) is currently involved in a concerning activity. The user can then act on this message as they deem appropriate.

In an embodiment, the user, via the mobile device (401), another computer, or the repeater (301) could also indicate that there is to be an authorized movement of the object (201) and prior to the object being moved, could temporarily disarm the device (100). In this way false alarms are avoided. This communication could occur by accessing a web page or by any other form of computer network interaction.

There is an advantage in using the repeater (301) or multiple repeaters (301) to obtain the signal from the device (100). In particular, the end user's mobile device (401) does not need to be within any particular range of the device (100) to receive the signal. Thus, the user's mobile device (401) can be significantly out of range of the transmitter (107) (even if it is capable of receiving signals from it) and still receive an indication of the movement of the device (100). Further, the repeater's (301) network connection can be monitored for interruption in a standard fashion as is done for existing home security devices. Thus, should one attempt to defeat the repeater (301) receiving the signal from the device (100), that attempt could itself trigger an alarm.

There are a couple of primary advantages of the device (100) over prior motion sensors and trackers. The first is that the device (100) is designed to detect motion of itself (and, therefore, generally the object (201) to which it is attached), not motion of something around it. Thus, it has far lower power requirements and can be placed in locations where there is movement nearby on a regular basis, for example in a busy retail store.

Further, because the device (100) detects its movement, it is very hard to thwart the device (100) communicating a change of state. Attempting to remove, or even damage, the device (such as by smashing it) can potentially result in it transmitting its message that the motion has changed prior to it being disabled, and the action can be acted upon. Further, because the device (100) can be small it can be attached in a variety of places where it is very difficult to get at it without moving it.

As an example, the device (100) could be placed on the interior of the door of a safe. As such, it would detect (and transmit) that the door is being opened generally before the device (100) can ever be accessed through the opening. Similarly, it can be attached to the rear of a television (or within its case) where a person is simply unable to reach it without moving the object (201) to which it is attached. Further, as the device (100) is designed to detect a change in motion, specific types of motion may be eliminated as not being alarm situations while others are not. For example, the device (100) attached to the back of a television may not detect that horizontal motion triggers an alarm situation, which would allow the television to rotate on a fixed stand, while still indicating that any form of vertical motion was an alarm situation.

The differentiation of types of motion (e.g. alarm vs. allowed) can be implemented by processor (109) utilizing motion stored in memory (111). In an embodiment, the types of allowed and disallowed motion can be programmed into the memory (111) by placing the device (100) and having it record a number of allowed motions and/or alarm motions through its own actions. As would be understood by one of ordinary skill in the art, functionality of any of the actions of the device (100), repeater (301), or mobile device (401) can be provided through appropriate software running on any or all of the relevant items.

Further, as the device (100) is generally designed to communicate with a repeater (301), as opposed to directly with the mobile device (401) or remote computer to which the communication is ultimately intended, there is no need for the device (100) to be in close proximity to the resultant alarm point. This can allow for a silent or remote alarm and can allow for the alarm situation to be customized based on the desired trigger.

For example, in an embodiment, the device may be placed on a liquor cabinet door and the repeater (301) can be placed elsewhere in the house and within Bluetooth™ range of the device. In an embodiment, it would actually be hidden or even built into the infrastructure of the house (such as within a wall) to inhibit it being located and disabled. The owner of the house could then go to work leaving teenagers at home. If the liquor cabinet was opened, the device (100) would send a message to the repeater (301). The repeater (301), could then call the owner's smartphone (401) using cellular communication or send them an email using a wired or wireless Internet connection to their office computer. This allows for the device to have a much greater notification range than if it was a pure Bluetooth™ communication. Further, there has been no local indicator that the activity (the motion) has been detected locally resulting in what is effectively a silent alarm. Further, this alarm situation can occur effectively in real-time.

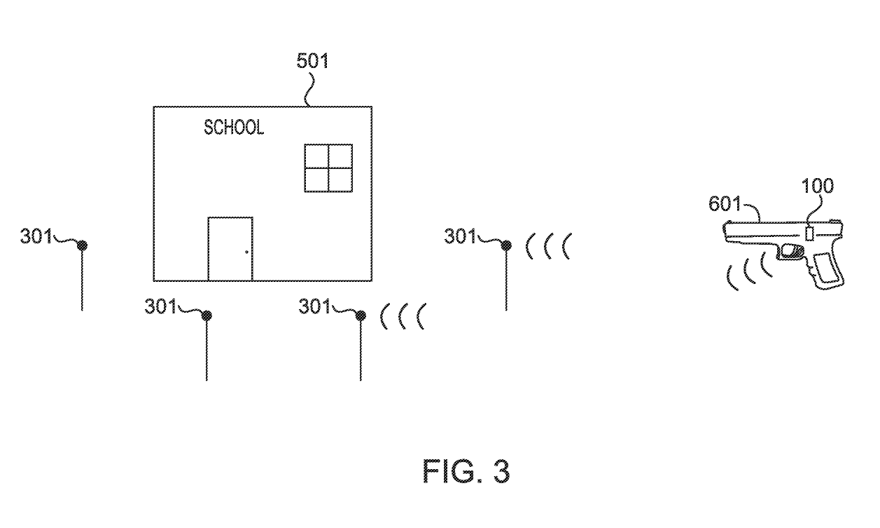

Using a repeater (301) also allows for additional functionality. For example, the devices (100) could be incorporated into firearms. In addition to the use of repeaters (301) to detect if the firearm is inappropriately moved (for example, by being taken from a box in a closet), repeaters (301) could also be positioned to form a perimeter around a sensitive location where possession of firearms was not permitted under most circumstances. For example, the grounds of a school (501) as shown in FIG. 3. In the event that a firearm (601) was brought into proximity of a repeater (301) (again, for example, Bluetooth range) the repeater (301) could notify a central alarm system at the school (501) of a potential danger situation and initiate an automated lockdown or alarm situation effectively in real-time.

This perimeter breach security system provides for a significant benefit over other early warning systems as the device (100) can be easily universally incorporated into dangerous devices, such as firearms (601) due to its small size. Further, since the device (100) need only transmit a basic change in movement indication and no identifying or positioning information, it can avoid privacy concerns related to the tracking of legitimate firearm uses. Effectively, the firearm would only be detected when it is within range of a repeater (301) which is, effectively, a place where it isn't allowed to be by the placement of a repeater to detect such location.

Another advantage of the device (100) is that it is not limited to an alarm situation of motion. It can also detect a change of state where the alarm is stillness and transmit that it is no longer in motion. For example, the device could be placed on a device that is expected to be in motion and where motion stops, such needs to be detected. The motion need not be constant or repetitive motion, but may simply be some form of motion (that is the opposite of the device being still). In an embodiment, it could comprise essentially constant state of random motion. The motion also need not be constant, but could be mostly constant. E.g. that the device is in motion 50, 55, 59, or 59.9 seconds of every minute or that it has no periods of stillness longer than 0.1, 1, 3, or 5 seconds, for example.

A simple example is to place the device (100) in a flow in a pipeline where a steady state of motion is to be expected to make sure that the flow is constantly moving and no portion is getting hung up. Similarly, the device could be placed on a wind turbine blade to indicate that the turbine is generating power (rotating) or within a coastal area where wave motion would be expected constantly.

Still further, the device could be implanted on a human organ (such as the heart or lung) or placed on a person's chest. While these items are not in constant motion, they are in a constant steady state of motion (that is they should almost always be moving with periods of lack of motion being relatively very short). Further, the ceasing of such motion (e.g. that a heart was no longer beating or lungs were no longer expanding and contracting) could clearly indicate a potential alarm situation.

Embodiments of use of such a constant motion detector could be to include it as part of a hospital gown, adhesive tab, or chest strap for patients where there is concern that the patient could stop breathing. Similarly, it could be incorporated into a swaddle cloth or pajama for an infant to provide reassurance to a parent that their child is breathing while they are asleep. It could also be implanted.

The inclusion of a digital processor (109) and memory (111) is designed to allow for additional features and functionality. As discussed above, in an embodiment, the device can simply transmit that motion is occurring until the battery or other power source (105) is out of power or the device (100) ceases to function (for example, by being smashed). However, even a single transmission may be enough to alert the user of the situation and depending on the type of movement detected, trigger an alarm scenario. Alternatively, the processor (109) and memory combination (111) can allow for more explicit tracking of motion allowing certain kinds of motion to be disregarded while others trigger alarms (and even different kinds of alarms).

The processor (109) and memory (111) may provide for additional features in that certain information can be stored on the device and the processor (109) (potentially being uploaded as a “burst” at a later time to the repeater (301)) which may perform certain functions to better indicate the situation as an alarm versus an unexpected, but not concerning, change in state. In an example, the processor (109) may be able, using dead reckoning or another method, to determine the distance that the device has moved. Thus, a distance of less than an inch may be discarded as irrelevant by the processor (or by an end user) while a distance of multiple feet may trigger an immediate alarm situation. Similarly, the device (100) may be able to distinguish different types of motion, such as breathing vs. walking, and provide an alarm if one of these situations occurs while another does not. For example, in the hospital situation, a bed-bound patient could be monitored for the steady state of movement for breathing, and a first alarm could be triggered if a state of walking is detected while a second alarm is triggered if the breathing motion is not detected, and a third alarm could be triggered if a sudden vertical movement (indicative of falling) is detected.

In order to provide further functionality, the device (100) may optionally include other components such as global location systems (e.g. GPS) communication devices to provide for improved location recognition, or may include additional detectors including those for temperature, moisture, or sound.

In a still further embodiment, the system can be used to monitor movement with an alarm situation being that the object has moved in a particular fashion and particularly that is has moved a particular distance from the repeater (301). In particular, a device (100) could be placed on an animal such as a domestic pet which will generally have an allowed roaming area (e.g. the owner's house and yard). By placing the repeater (301) in the house or in a peripheral “fence”, the system can now work in an inverse fashion to the embodiment of FIG. 3 to provide an invisible fence. In FIG. 3 detection of the proximity of the device triggered an alarm (essentially that the device was in range of the repeater (301)). In the invisible fence scenario, detection that the device (100) moving or has moved a particular distance from the repeater (301) (e.g. to the edge of its range or beyond its range) could trigger the alarm situation.

This alarm could then trigger external notification as contemplated above, or could trigger an onboard additional activity in device (100). For example, in an embodiment, the device moving out of range of the repeater (301) could cause the device to issue a small electric shock to convince a domestic animal to return to its allowed area. Alternatively, the alarm could trigger a more powerful transmitter (for example a transmitter utilizing Wi-Fi standards, cellular telephony, or handheld radio channels) to obtain a signal and send a powerful signal that there is a concern due to the lack of range of the device (100) and repeater (300). This can be particularly valuable when coupled with a GPS or other transmitter capable of indicating an exact location as the device (100) can be configured to only transmit its precise location, when that location is outside the desired steady state location.

The major value of this last embodiment is that it provides for much less power consumption than attempting to track the device (100) in an absolute fashion. Generally, a Bluetooth™ transmission requires significantly less power than a GPS signal coupled with a cellular telephone transmission. This provides for a device which can have significantly greater battery life than those types of devices that are reliant on absolute positioning at all times to determine the location. In effect, the present device (100) is again registering a steady state (in this case that the domestic animal is within its allowed area) and only triggers alternative alarm situations when that steady state is breached.

While the value of being able to confine a domestic animal to an area without the need for buried wires should be clear, it should also be apparent that the device can be particularly useful for animals that are often left in remote locations, or are otherwise unmonitored currently, for relatively long periods of time where changing or charging batteries on the device can be highly inconvenient or even dangerous. For example, placing devices (100) on beef cattle that are allowed to graze within a fenced area (or within a certain remote grazing area using a transportable repeater (301)) can allow a rancher to detect and be warned if a cow gets out or wanders out of the expected area. Further, this can come essentially in real-time after the cow escapes allowing the rancher to quickly respond even if they are a great distance away.

Such a use is particularly valuable as well for Zoo animals or other confined animals where them getting out of a prepared enclosure can result in an immediate emergency situation. Further, should a poacher attempt to steal one of the animals, or if it was killed by a predator, even if within the confined area, the ceasing of movement (its breathing, heartbeat, and/or physical translation), its movement outside the area by the poacher, or the poacher dropping the device (100) on the ground and it no longer sensing movement could be detected and again immediately reported allowing for a response.

While the above is particularly focused on the discussion of alarm situations and remote notification, the device (100) can also clearly be used to gather data on confined populations, including movement within the confined area, and changes in certain regular movements. This can potentially be used to detect physiological changes, such as a dairy cow entering a breeding cycle, as well as population dynamics, such as how often a particular herd of cattle has been scared into defensive positioning or how the herd moves over time in a larger grazing area. The device can also be used for inventory tracking allowing any item with a device to be singled out and individually located or tracked as would be understood by one of ordinary skill in the art.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A system for detecting a change in steady state comprising:
a detection device, said detection device attached to an object having a steady state and including a motion detector;
a repeater remote from said detection device; and
a receiver remote from both said detection device and said repeater;
wherein, when motion is detected by said motion detector, said device transmits an indication of said motion to said repeater; and
wherein, said repeater transmits an indication of said motion to said remote receiver.

2. The system of claim 1 wherein said steady state is a stationary state.

3. The system of claim 1 wherein said steady state is continuous or near-continuous motion.

4. The system of claim 1 wherein said device transmits to said repeater using a short ranged and low power communication protocol.

5. The system of claim 4 wherein said protocol is Bluetooth™.

6. The system of claim 1 wherein said repeater transmits to said receiver using a computer network.

7. The system of claim 6 wherein said network is the Internet.

8. The system of claim 1 wherein said repeater transmits to said receiver using a cellular telephone signal.

9. The system of claim 1 wherein said remote receiver is a computer.

10. The system of claim 1 wherein said remote receiver is a mobile device.

11. A system for detecting the location of an object comprising:
a detection device, said detection device attached to an object and including a transmitter;
a repeater remote from said detection device and including a receiver; and
a computer remote from both said detection device and said repeater and in communication with said repeater;
wherein, said repeater automatically triggers an alarm situation when said transmitter gets into communication with said receiver; and
wherein, said alarm situation is transmitted by said repeater to said computer.

12. The system of claim 11 wherein said computer is a mobile device.

13. The system of claim 11 wherein said detection device transmits to said repeater using a short ranged and low power communication protocol.

14. The system of claim 13 wherein said protocol is Bluetooth™.

15. The system of claim 11 wherein said repeater transmits to said computer over a network.

16. The system of claim 15 wherein said network is the Internet.

17. The system of claim 11 wherein said repeater transmits to said receiver using a cellular telephone signal.

18. A system for detecting the location of an object comprising:
a detection device, said detection device attached to an object and including a first transmitter and a second transmitter;
a repeater remote from said detection device and including a receiver; and
a computer remote from both said detection device and said repeater and in communication with said repeater;
wherein, said repeater automatically triggers an alarm situation when said first transmitter loses communication with said receiver;
wherein, said detection device switches from using said first transmitter to said second transmitter only when said first transmitter loses communication with said receiver;
wherein said second transmitter communicates with said computer without using said repeater; and
wherein, said alarm situation is transmitted by said repeater to said computer.
